(19) United States
(12) Patent Application Publication
(10) Pub. No.: US 2019/0236269 A1
(43) Pub. Date: Aug. 1, 2019

(54) DETECTING THIRD PARTY SOFTWARE ELEMENTS

(71) Applicant: INTERNATIONAL BUSINESS MACHINES CORPORATION, ARMONK, NY (US)

(72) Inventor: ROEE HAY, HAIFA (IL)

(21) Appl. No.: 15/884,472

(22) Filed: Jan. 31, 2018

(51) Int. Cl. G06F 21/54; G06F 21/57; G06F 11/36

(52) U.S. Cl. CPC G06F 21/54; G06F 21/577; H04L 9/0637; G06F 11/3688; G06F 11/3684

(57) ABSTRACT

In some examples, a system for detecting a third party software element can include a processor to generate a software element signature for each software element detected in a plurality of applications in a repository. The processor can also detect third party software elements by identifying software elements that are included in a number of the plurality of applications that exceeds a threshold value. Additionally, the processor can generate a test signature corresponding to at least one software element in an application to be tested and compare the test signature to each of the software element signatures corresponding to the third party software elements. Furthermore, the processor can detect that the test signature matches at least one of the third party software elements with a security vulnerability and modify the application to be tested to prevent execution of the at least one software element corresponding to the test signature.

### BACKGROUND

The present disclosure relates to software elements, and more specifically, but not exclusively, to detecting third party software elements with a security vulnerability.

### SUMMARY

According to an embodiment described herein, a system for detecting a third party software element can include a processor to generate a software element signature for each software element detected in a plurality of applications in a repository. The processor can also detect third party software elements by identifying software elements that are included in a number of the plurality of applications, wherein the number exceeds a threshold value, and generate a test signature corresponding to at least one software element in a software application to be tested. Additionally, the processor can compare the test signature to each of the software element signatures corresponding to the third party software elements and detect that the test signature matches at least one of the third party software elements with a security vulnerability. Furthermore, the processor can modify the application to be tested to prevent execution of the at least one software element corresponding to the test signature.

According to another embodiment, a method for detecting a third party software element can include generating a software element signature for each software element detected in a plurality of applications in a repository. The method can also include detecting third party software elements by identifying software elements that are included in a number of the plurality of applications, wherein the number exceeds a threshold value, and generating a test signature corresponding to at least one software element in a software application to be tested. Additionally, the method can include comparing the test signature to each of the software element signatures corresponding to the third party software elements and detecting that the test signature matches at least one of the third party software elements with a security vulnerability. Furthermore, the method can include modifying the application to be tested to prevent execution of the at least one software element corresponding to the test signature

According to another embodiment, a computer program product for detecting a third party software element can include a computer readable storage medium having program instructions embodied therewith, wherein the computer readable storage medium is not a transitory signal per se. The program instructions can be executable by a processor to cause the processor to generate a software element signature for each software element detected in a plurality of applications in a repository. The processor can also detect third party software elements by identifying software elements that are included in a number of the plurality of applications, wherein the number exceeds a threshold value, and generate a test signature corresponding to at least one software element in a software application to be tested. Additionally, the processor can compare the test signature to each of the software element signatures corresponding to the third party software elements and detect that the test signature matches at least one of the third party software elements with a security vulnerability. Furthermore, the processor can modify the application to be tested to prevent execution of the at least one software element corresponding to the test signature

### BRIEF DESCRIPTION OF THE DRAWINGS

FIG. 1 depicts a block diagram of an example computing system that can detect a third party software element according to an embodiment described herein;

FIG. 2 is a process flow diagram of an example method that can detect a third party software element according to an embodiment described herein;

FIG. 3 is a tangible, non-transitory computer-readable medium that can detect a third party software element according to an embodiment described herein;

FIG. 4 depicts an illustrative cloud computing environment according to an embodiment described herein; and

FIG. 5 depicts a set of functional abstraction layers provided by a cloud computing environment according to an embodiment described herein.

### DETAILED DESCRIPTION

Applications can incorporate software code from any number of third party software providers. For example, third party software providers may provide functions, methods, classes, and the like, which implement predeveloped functionality. In some examples, the third party software can provide user interfaces, implementations of existing protocols, and user input functions, among others. In some examples, the third party software can include security vulnerabilities that are detected at a later date after releasing the third party software to the public. Accordingly, the third party software may be incorporated into a large number of applications prior to detection of the security vulnerability. Therefore, users may not be able to determine if an application being executed includes third party software with a security vulnerability.

In some embodiments described herein, a device for detecting a third party software element can generate a software element signature for each software element detected in a plurality of applications in a repository. The device can detect third party software elements by identifying software elements that are included in a number of the plurality of applications that exceeds a threshold value. Additionally, the device can generate a test signature corresponding to at least one software element in an application to be tested and compare the test signature to each of the software element signatures corresponding to the third party software elements. Furthermore, the device can detect that the test signature matches at least one of the third party software elements with a security vulnerability and modify the application to be tested to prevent execution of the at least one software element corresponding to the test signature.

Accordingly, the techniques described herein can prevent execution of software applications with known security vulnerabilities included in third party software elements. In some embodiments, the techniques described herein can prevent unauthorized data access by preventing third party software elements with security vulnerabilities from being executed.

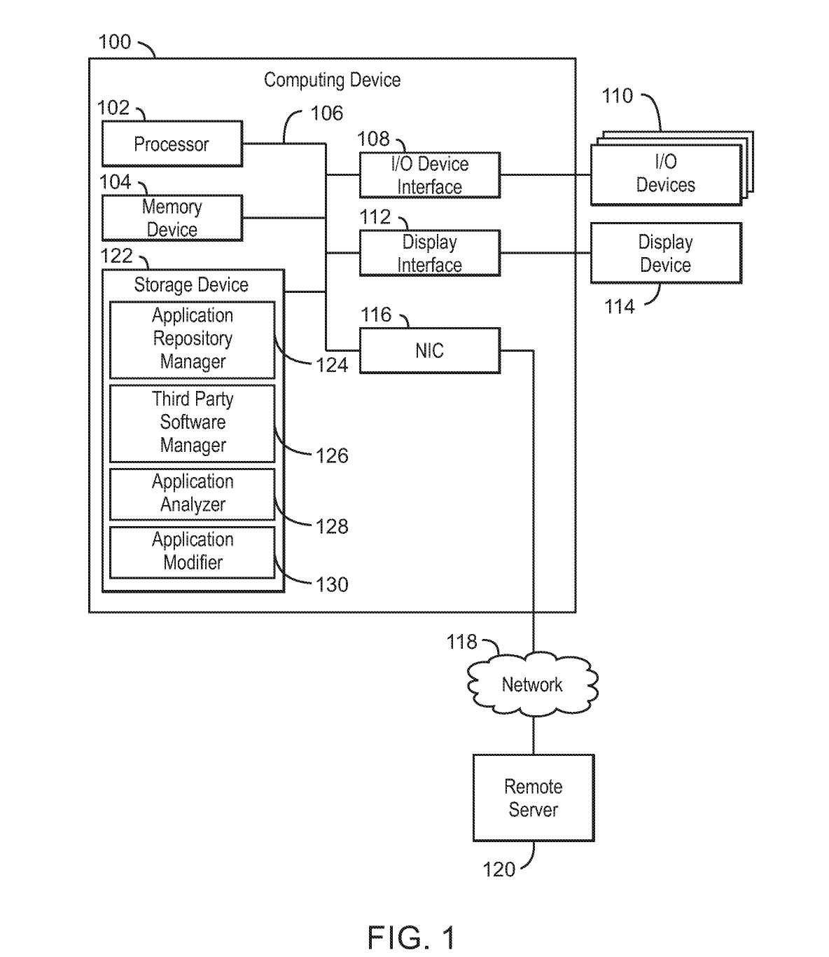

With reference now to FIG. 1, an example computing device is depicted that can detect a third party software element. The computing device 100 may be for example, a server, desktop computer, laptop computer, tablet computer, or smartphone. In some examples, computing device 100 may be a cloud computing node. Computing device 100 may be described in the general context of computer system executable instructions, such as program modules, being executed by a computer system. Generally, program modules may include routines, programs, objects, components, logic, data structures, and so on that perform particular tasks or implement particular abstract data types. Computing device 100 may be practiced in distributed cloud computing environments where tasks are performed by remote processing devices that are linked through a communications network. In a distributed cloud computing environment, program modules may be located in both local and remote computer system storage media including memory storage devices.

The computing device 100 may include a processor 102 that is adapted to execute stored instructions, a memory device 104 to provide temporary memory space for operations of said instructions during operation. The processor can be a single-core processor, multi-core processor, computing cluster, or any number of other configurations. The memory 104 can include random access memory (RAM), read only memory, flash memory, or any other suitable memory systems.

The processor 102 may be connected through a system interconnect 106 (e.g., PCI®, PCI-Express®, etc.) to an input/output (I/O) device interface 108 adapted to connect the computing device 100 to one or more I/O devices 110. The I/O devices 110 may include, for example, a keyboard and a pointing device, wherein the pointing device may include a touchpad or a touchscreen, among others. The I/O devices 110 may be built-in components of the computing device 100, or may be devices that are externally connected to the computing device 100.

The processor 102 may also be linked through the system interconnect 106 to a display interface 112 adapted to connect the computing device 100 to a display device 114. The display device 114 may include a display screen that is a built-in component of the computing device 100. The display device 114 may also include a computer monitor, television, or projector, among others, that is externally connected to the computing device 100. In addition, a network interface controller (NIC) 116 may be adapted to connect the computing device 100 through the system interconnect 106 to the network 118. In some embodiments, the NIC 116 can transmit data using any suitable interface or protocol, such as the internet small computer system interface, among others. The network 118 may be a cellular network, a radio network, a wide area network (WAN), a local area network (LAN), or the Internet, among others. A remote server 120 may connect to the computing device 100 through the network 118.

The processor 102 may also be linked through the system interconnect 106 to a storage device 122 that can include a hard drive, an optical drive, a USB flash drive, an array of drives, or any combinations thereof. In some examples, the storage device 122 may include an application repository manager 124, a third party software manager 126, an application analyzer 128, and an application modifier 130. In some embodiments, the application repository manager 124 can generate a software element signature for each software element detected in a plurality of applications in a repository. In some embodiments, the third party software manager 126 can detect third party software elements by identifying software elements that are included in a number of the plurality of applications that exceeds a threshold value. In some embodiments, the application analyzer 128 can generate a test signature corresponding to at least one software element in an application to be tested. In some embodiments, the application analyzer 128 can also compare the test signature to each of the software element signatures corresponding to the third party software elements. Furthermore, the application analyzer 128 can detect that the test signature matches at least one of the third party software elements with a security vulnerability. In some examples, the application modifier 130 can modify the application to be tested to prevent execution of the at least one software element corresponding to the test signature.

It is to be understood that the block diagram of FIG. 1 is not intended to indicate that the computing device 100 is to include all of the components shown in FIG. 1. Rather, the computing device 100 can include fewer or additional components not illustrated in FIG. 1 (e.g., additional memory components, embedded controllers, modules, additional network interfaces, etc.). Furthermore, any of the functionalities of the application repository manager 124, third party software manager 126, application analyzer 128, and application modifier 130 may be partially, or entirely, implemented in hardware and/or in the processor 102. For example, the functionality may be implemented with an application specific integrated circuit, logic implemented in an embedded controller, or in logic implemented in the processor 102, among others. In some embodiments, the functionalities of the application repository manager 124, third party software manager 126, application analyzer 128, and application modifier 130 can be implemented with logic, wherein the logic, as referred to herein, can include any suitable hardware (e.g., a processor, among others), software (e.g., an application, among others), firmware, or any suitable combination of hardware, software, and firmware.

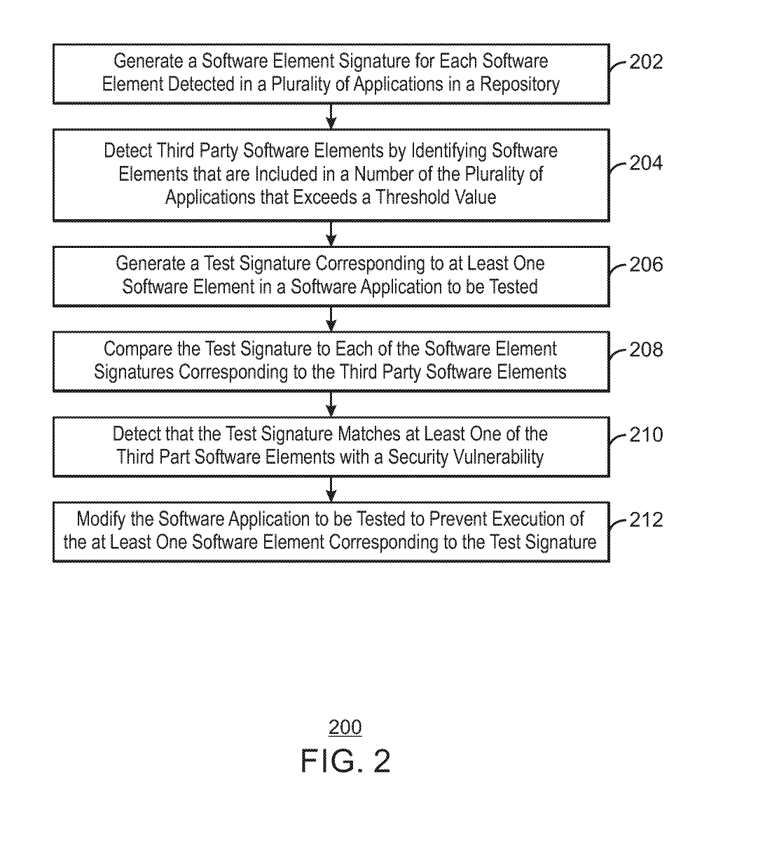

FIG. 2 is a process flow diagram of an example method that can detect a third party software element. The method 200 can be implemented with any suitable computing device, such as the computing device 100 of FIG. 1.

At block 202, an application repository manager 124 can generate a software element signature for each software element detected in a plurality of applications in a repository. In some embodiments, the repository can include any suitable number of applications that can be executed on mobile devices, desktop computing devices, remote servers implementing network based services, also known as cloud services, and the like. Each application can include any number of software elements. As discussed above, a software element can include a class, a function, a method, and the like. In some examples, each software element can include any number of different instructions in any suitable number of programming languages.

The application repository manager 124 can generate a software element signature for each software element of each application. The software element signature can be a value resulting from applying a hash function to information derived from a software element. In some examples, the application repository manager 124 can assign a software element signature to a software element using any suitable hashing function such as a Merkle-Damgard construction, such as MD5, a secure hash algorithm, such as SHA-1, SHA-2, or SHA-3, or any other suitable hashing algorithm.

In some embodiments, the application repository manager 124 may detect bytecode for each application and determine a number of each type of instructions in each software element of the application based on the bytecode. Accordingly, the application repository manager 124 can generate the software element signatures using binary forms of applications that are disassembled, but not decompiled. In some examples, the application repository manager 124 can ignore the software element name, which may be modified or configured differently between separate software applications. The application repository manager 124 can also assign software element signatures to software elements that have a similarity rating above a predetermined threshold. For example, a software application may change the name of a function called in a software element. However, the application repository manager 124 may assign the same software element signature to the function as a second function if the remaining instructions, variables, function calls, and the like, are the same. In some embodiments, the application repository manager 124 can compute a software element signature using a same hash value for each set or cluster of similar software elements.

At block 204, a third party software manager 126 can detect third party software elements by identifying software elements that are included in a number of the plurality of applications that exceeds a threshold value. For example, the third party software manager 126 may determine that a software element signature that corresponds to a predetermined number of applications is likely a third party software element. As discussed above, a third party software element can include any suitable software elements that are shared between applications and frequently inserted into applications to provide predeveloped functionality. For example, third party software elements may detect user input using previously developed techniques, generate user interfaces, and the like. The third party software manager 126 can determine that a software element is likely a third party software element if the software element is included in a number of applications of a repository, wherein the number of applications exceeds a threshold value. The third party software manager 126 may detect the threshold value of applications that indicate a third party software element from any suitable source.

At block 206, an application analyzer 128 can generate a test signature corresponding to at least one software element in an application to be tested. In some embodiments, the application analyzer 128 can receive an application to test against the applications of the repository. The application to be tested may be detected from a remote computing device, through a remote server service, a mobile device, a local storage device, and the like. In some embodiments, the application analyzer 128 can detect the number of software elements in the application to be tested and generate a test signature for each software element. In some examples, each test signature can be a value resulting from applying a hash function to information derived from a software element. In some examples, the application analyzer 128 can assign a software element signature to a software element using any suitable hashing function such as MD5, OSHA1 or any suitable hashing algorithm.

In some embodiments, the application analyzer 128 may detect bytecode for the application being tested and determine a number of each type of instructions in each software element of the application based on the bytecode. Accordingly, the application analyzer 128 can generate the test signature using a binary form of an application to be tested without decompiling the application. As with the software element signatures from the repository, the application analyzer 128 can ignore or exclude the corresponding software element name, which may be configured differently between separate software applications. In some embodiments, the application analyzer 128 can compute each test signature independently of previously detected software elements. In some examples, the application analyzer 128 can assign a test signature to each element of the application being tested based on a comparison of the software element of the application to previously detected software elements from the application repository.

At block 208, the application analyzer 128 can compare the test signature to each of the software element signatures corresponding to the third party software elements. For example, the application analyzer 128 can detect a similarity between the test signature and software element signatures of third party software elements. In some embodiments, the application analyzer 128 can detect the similarity between the test signature and software elements signatures of third party software elements using any suitable equality relation technique or binary relation technique, among others.

At block 210, the application analyzer 128 can detect that the test signature matches at least one of the third party software elements with a security vulnerability. For example, the application analyzer 128 can detect that a similarity of a test signature and a signature of a third party software element exceeds a threshold value. The application analyzer 128 may also have access to information indicating whether each software element has a security vulnerability. For example, the security vulnerabilities may include allowing user input that exceeds a buffer size, allowing user input that includes scripting characters, executing database commands without checking for scripting characters, and the like. In some embodiments, the security vulnerability can include cross-application scripting via operating system specific intent uniform resource locators (URLs). For example, the security vulnerability can enable a specially-crafted URL to cause a browser application to be initiated with a different start page than the developer of the browser intended. In some examples, the different start page may include Hyper Text Markup Language (HTML) content stored on a mobile device. In some embodiments, the security vulnerabilities of each third party software element can be stored in the repository or any other suitable memory location. In some embodiments, the security vulnerabilities can be stored with any suitable data structure such as an array, vector, linked list, and the like. The security vulnerabilities may be indicated with bit indicators, wherein each bit indicator corresponds to a different security vulnerability. The security vulnerabilities can be populated by the application repository manager 124 in some embodiments.

At block 212, an application modifier 130 can modify the application to be tested to prevent execution of the at least one software element corresponding to the test signature. For example, the application modifier 130 can detect that a third party software element of an application to be tested has any suitable number of security vulnerabilities. The application modifier 130 can determine that the instructions of the software element are not to be executed and the application modifier 130 can modify the binary file of the new application being tested to prevent execution of the third party software element. In some embodiments, the application modifier 130 can prevent execution of the entire application being tested.

In some examples, the application modifier 130 can generate an alert or menu to be displayed in a graphical user interface with information corresponding to the security vulnerabilities of the third party software element in the application being tested. In some examples, the application modifier 130 can detect a ranking of security vulnerabilities and can execute the application being tested if the security vulnerabilities of a third party software element are below a threshold security ranking. For example, the application modifier 130 may determine that security vulnerabilities with low exploitability are a lower priority or ranking than security vulnerabilities with high exploitability. Accordingly, the application modifier 130 may allow execution of third party software elements involving buffer security vulnerabilities, but not allow execution of software elements involving scripting character security vulnerabilities. In some examples, the application modifier 130 can also detect a classification of an application being tested. For example, the application may include user input corresponding to confidential information or the application may access databases and other data resources that store confidential information. The application modifier 130 may prevent execution of any third party software element with a security vulnerability for applications with a particular classification, while allowing lower classified applications to access software elements with lower priority security vulnerabilities.

The process flow diagram of FIG. 2 is not intended to indicate that the operations of the method 200 are to be executed in any particular order, or that all of the operations of the method 200 are to be included in every case. For example, the third party software manager 126 can also generate a global histogram for the plurality of applications, wherein the global histogram indicates the number of the plurality of applications that include each of the software components. The application analyzer 128 may determine the number of applications that include the software element based on the global histogram. In some embodiments, the application repository manager 124 can generate the software element signatures based on a binary representation of each of the plurality of applications in the repository.

In one example, the techniques described herein can use a similarity of hash function values to determine if a software element is a third party software element. For example, techniques described herein can compute a signature of a class by creating a sorted list of the opcodes of the class and computing a hash of the sorted list with any suitable hashing technique such as a Murmur Hash. The class can be detected as a third party software element if the class is included in a percentage of applications above a threshold value. For example, if more than 6% of applications for a specific operating system include the class, then the class is likely third party software. In some examples, any suitable percentage can be used to designate classes as third party software.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

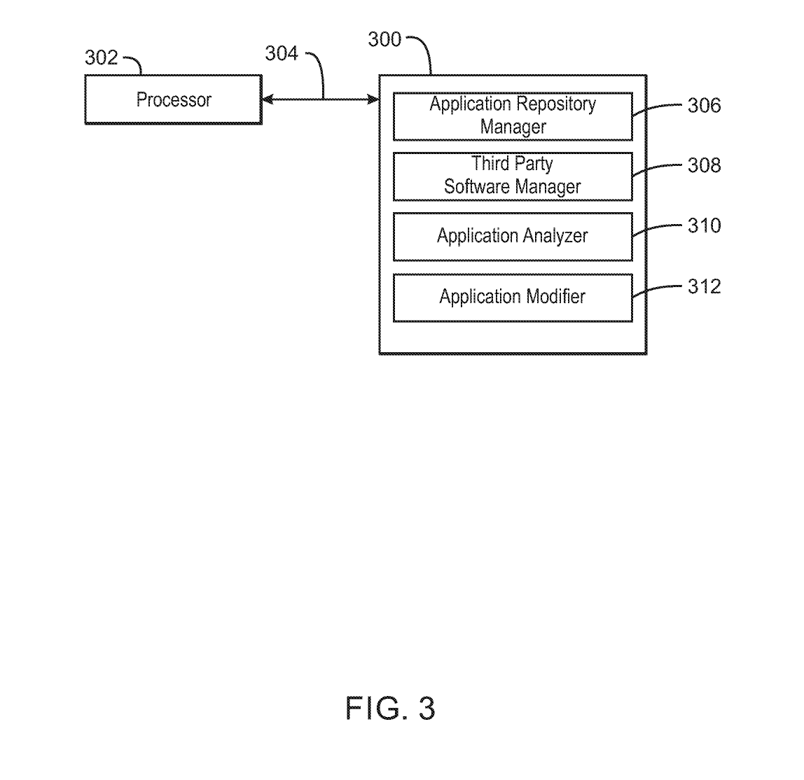

Referring now to FIG. 3, a block diagram is depicted of an example of a tangible, non-transitory computer-readable medium that can detect a third party software element. The tangible, non-transitory, computer-readable medium 300 may be accessed by a processor 302 over a computer interconnect 304.

Furthermore, the tangible, non-transitory, computer-readable medium 300 may include code to direct the processor 302 to perform the operations of the current method. For example, an application repository manager 306 can generate a software element signature for each software element detected in a plurality of applications in a repository. In some embodiments, a third party software manager 308 can detect third party software elements by identifying software elements that are included in a number of the plurality of applications that exceeds a threshold value. In some embodiments, an application analyzer 310 can generate a test signature corresponding to at least one software element in an application to be tested. In some embodiments, the application analyzer 310 can also compare the test signature to each of the software element signatures corresponding to the third party software elements. Furthermore, the application analyzer 310 can detect that the test signature matches at least one of the third party software elements with a security vulnerability. In some examples, an application modifier 312 can modify the application to be tested to prevent execution of the at least one software element corresponding to the test signature.

It is to be understood that any number of additional software components not shown in FIG. 3 may be included within the tangible, non-transitory, computer-readable medium 300, depending on the specific application. Furthermore, fewer software components than those shown in FIG. 3 can be included in the tangible, non-transitory, computer-readable medium 300.

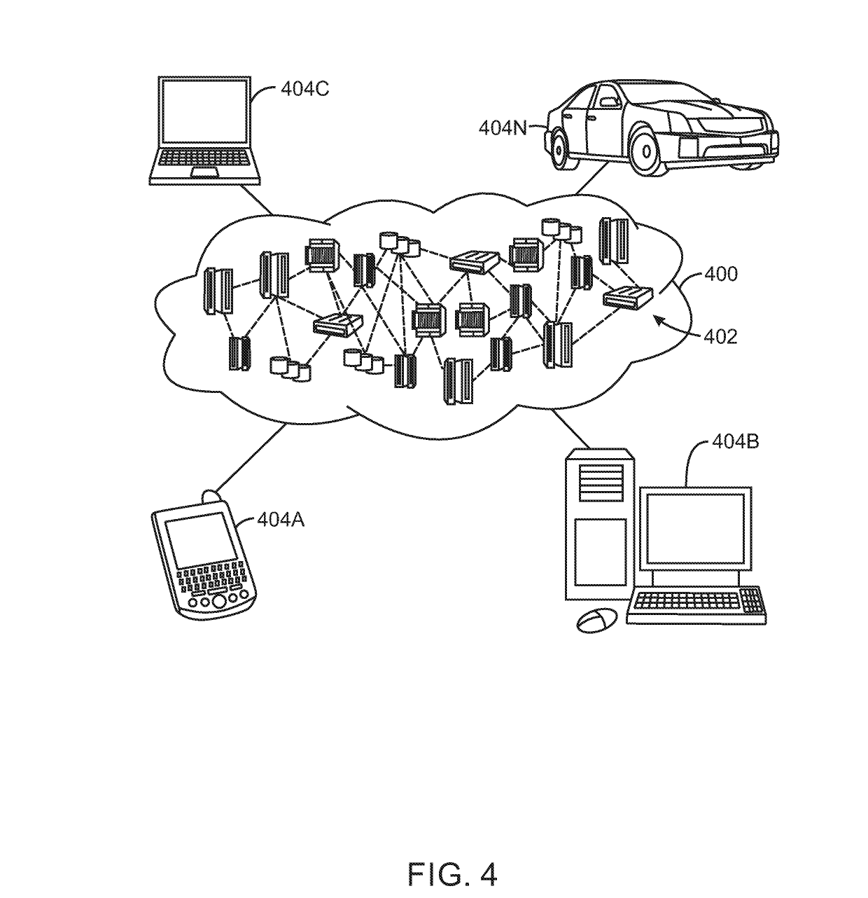

Referring now to FIG. 4, illustrative cloud computing environment 400 is depicted. As shown, cloud computing environment 400 comprises one or more cloud computing nodes 402 with which local computing devices used by cloud consumers, such as, for example, personal digital assistant (PDA) or cellular telephone 404A, desktop computer 404B, laptop computer 404C, and/or automobile computer system 404N may communicate. Nodes 402 may communicate with one another. They may be grouped (not shown) physically or virtually, in one or more networks, such as Private, Community, Public, or Hybrid clouds as described hereinabove, or a combination thereof. This allows cloud computing environment 400 to offer infrastructure, platforms and/or software as services for which a cloud consumer does not need to maintain resources on a local computing device. It is understood that the types of computing devices 404A-N shown in FIG. 4 are intended to be illustrative only and that computing nodes 402 and cloud computing environment 400 can communicate with any type of computerized device over any type of network and/or network addressable connection (e.g., using a web browser).

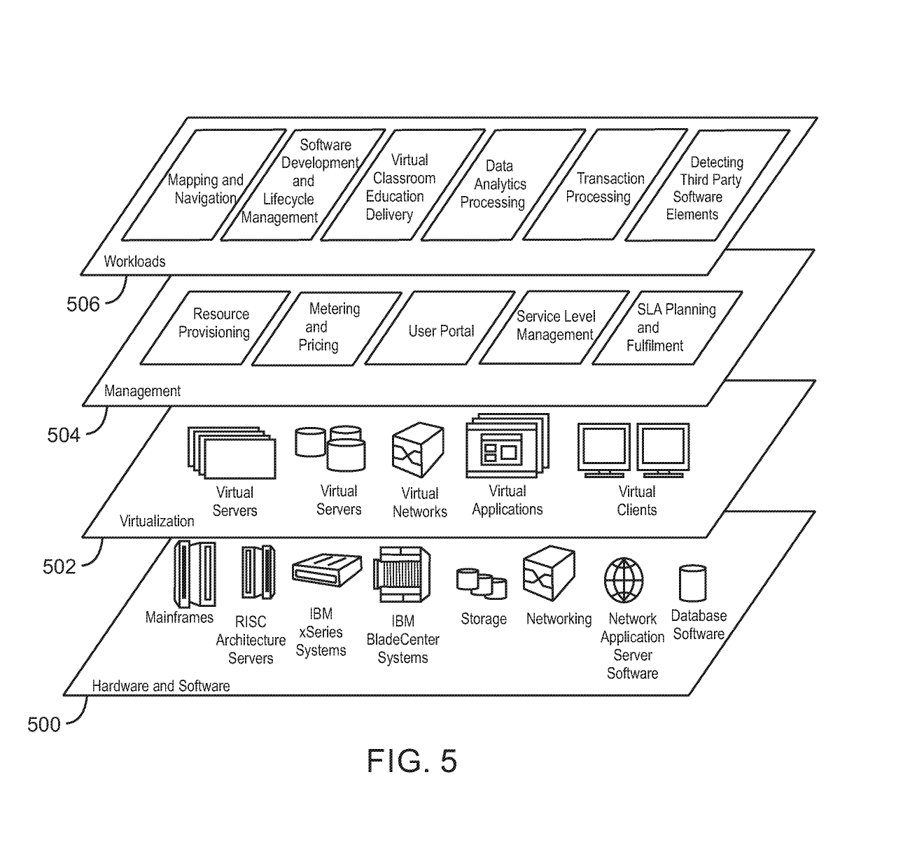

Referring now to FIG. 5, a set of functional abstraction layers provided by cloud computing environment 400 (FIG. 4) is shown. It should be understood in advance that the components, layers, and functions shown in FIG. 5 are intended to be illustrative only and embodiments of the invention are not limited thereto. As depicted, the following layers and corresponding functions are provided.

Hardware and software layer 500 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 502 provides an abstraction layer from which the following examples of virtual entities may be provided: virtual servers; virtual storage; virtual networks, including virtual private networks; virtual applications and operating systems; and virtual clients. In one example, management layer 504 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 506 provides examples of functionality for which the cloud computing environment may be utilized. Examples of workloads and functions which may be provided from this layer include: mapping and navigation; software development and lifecycle management; virtual classroom education delivery; data analytics processing; transaction processing; and detecting third party software elements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system for detecting a third party software element comprising:
a processor to:
generate a software element signature for each software element detected in a plurality of applications in a repository;
detect third party software elements by identifying software elements that are included in a number of the plurality of applications, wherein the number exceeds a threshold value;
generate a test signature corresponding to at least one software element in a software application to be tested;
compare the test signature to each of the software element signatures corresponding to the third party software elements;
detect that the test signature matches at least one of the third party software elements with a security vulnerability; and
modify the application to be tested to prevent execution of the at least one software element corresponding to the test signature.

2. The system of claim 1, wherein the processor is to prevent execution of the application to be tested.

3. The system of claim 1, wherein each of the software elements comprise a class, a method, or a function.

4. The system of claim 1, wherein the processor is to generate the software element signatures and the test signature based on a hash function that excludes a name of a corresponding software element.

5. The system of claim 1, wherein the processor is to generate a global histogram for the plurality of applications, wherein the global histogram indicates the number of the plurality of applications that include each of the software components.

6. The system of claim 1, wherein the processor is to generate the software element signatures based on a binary representation of each of the plurality of applications in the repository.

7. The system of claim 1, wherein the processor is to generate the software element signatures based on a number and a type of instructions in each software element.

8. A method for detecting a third party software element comprising:
generating a software element signature for each software element detected in a plurality of applications in a repository;
detecting third party software elements by identifying software elements that are included in a number of the plurality of applications that exceeds a threshold value;
generating a test signature corresponding to at least one software element in an application to be tested;
comparing the test signature to each of the software element signatures corresponding to the third party software elements;
detecting that the test signature matches at least one of the third party software elements with a security vulnerability; and
modifying the application to be tested to prevent execution of the at least one software element corresponding to the test signature.

9. The method of claim 8 comprising preventing execution of the application to be tested.

10. The method of claim 8, wherein each of the software elements comprise a class, a method, or a function.

11. The method of claim 8 comprising generating the software element signatures and the test signature based on a hash function that excludes a name of a corresponding software element.

12. The method of claim 8 comprising generating a global histogram for the plurality of applications, wherein the global histogram indicates the number of the plurality of applications that include each of the software components.

13. The method of claim 8 comprising generating the software element signatures based on a binary representation of each of the plurality of applications in the repository.

14. The method of claim 8 comprising generating the software element signatures based on a number and a type of instructions in each software element.

15. A computer program product for detecting a third party software element, the computer program product comprising a computer readable storage medium having program instructions embodied therewith, wherein the computer readable storage medium is not a transitory signal per se, the program instructions executable by a processor to cause the processor to:
generate a software element signature for each software element detected in a plurality of applications in a repository;
detect third party software elements by identifying software elements that are included in a number of the plurality of applications that exceeds a threshold value;
generate a test signature corresponding to at least one software element in an application to be tested;
compare the test signature to each of the software element signatures corresponding to the third party software elements;
detect that the test signature matches at least one of the third party software elements with a security vulnerability; and
modify the application to be tested to prevent execution of the at least one software element corresponding to the test signature.

16. The computer program product of claim 15, wherein the processor is to prevent execution of the application to be tested.

17. The computer program product of claim 15, wherein each of the software elements comprise a class, a method, or a function.

18. The computer program product of claim 15, wherein the processor is to generate the software element signatures and the test signature based on a hash function that excludes a name of a corresponding software element.

19. The computer program product of claim 15, wherein the processor is to generate a global histogram for the plurality of applications, wherein the global histogram indicates the number of the plurality of applications that include each of the software components.

20. The computer program product of claim 15, wherein the processor is to generate the software element signatures based on a number and a type of instructions in each software element.
